(19) United States
(12) Patent Application Publication
(10) Pub. No.: US 2019/0034070 A1
(43) Pub. Date: Jan. 31, 2019

(54) Flexible & customisable human computer interaction (HCI) device that combines the functionality of traditional keyboard and pointing device (mouse/touchpad) on a laptop & desktop computer

(71) Applicant: Sant Sevak Singh, Mount Waverly (AU)

(72) Inventor: Sant Sevak Singh, Mount Waverly (AU)

(21) Appl. No.: 15/663,777

(22) Filed: Jul. 30, 2017

(51) Int. Cl. G06F 3/0488; G06F 3/0354; G06F 3/0484; G06F 1/16

(52) U.S. Cl. CPC G06F 3/04883; G06F 3/03547; G06F 3/04886; G06F 3/04842; G06F 1/1616; G06F 1/166; G06F 1/169; G06F 1/1673; G06F 3/03545; G06F 1/1654

(57) ABSTRACT

Humans interact with computers using various input/output peripherals e.g. keyboards, touch pad, stylus, mouse and touchscreen etc. This novel HCI device, eliminates the physical limitations of traditional input methods i.e. keyboard & pointing devices like touchpad & mouse. This HCI device enables customisation of input for every & the specific use case. The HCI device operates in full touch pad mode, keyboard only mode and traditional mode. Based on specific triggers/conditions the switch between modes is quick and smart. The flexibility and hardware independence is achieved by replacing mechanical hardware with new non-mechanical touch based hardware and software that governs the new hardware. Different modes of operation are actuated based on the operational requirement, customisation &/or user preference. A trigger to initiate a mode is calculated by a combination of multiple sensor inputs, active software application, hands spatial location on pad, stylus state, buttons, gestures performed and user preferences. The novel HCI is either integrated into the laptop or in a standalone unit to fit existing laptops and desktops. The new HCI device provides independence from physical mechanical hardware limitations and provides unlimited customisation. This makes the new HCI device future proof and a true universal alphanumeric and pointing input instrument.

Refer to definitions and acknowledgements in Annex A.

Background/description of current laptop form factor and how it is used.

The Physical Form Factor: There are a few variations to physical form factor of a laptop. To mention are traditional lid closing, twisting display device & fold and detachable Display Device.
Some laptops have a touch capable display device, example type 1 & 2 shown above.
Some versions have a stylus like tool; example type 1 shown in above FIG. 1.

How it Works: Two big sections of real-estate on a laptop are marked as top panel and bottom panel. The top panel and bottom panel face each other and are normally at an angle in clamshell arrangement.

Top Panel
The top panel is covered with an I/O device and is typically used to output information to the user.
   Typically, a display device is used on the top panel that occupies full face or most of the top panel.
   There may or may not be a web cam.

Bottom Panel
The bottom panel hosts multiple I/O devices and is typically used to input to the computer.
   A mechanical keyboard
   A small touch pad.
   Speaker, buttons and empty space.

A traditional laptop device is shown in FIG. 2.

A laptop is used in traditional laptop use, a pure tablet and or combination of laptop or tablet.

### DESCRIPTION OF INNOVATION

The HCI innovation is explained using a laptop, as the prime application of the HCI innovation will be laptops. Other types are listed in section 2.3.2.6

The novel of idea lies in hardware changes on the bottom panel, software that governs the new hardware, the modes of operation and the methods of actuation of modes.

New Hardware:
The physical keyboard and the touch pad is removed from the bottom panel.
The bottom panel is installed with a giant touch pad. The touch pad occupies full/near-full face of the bottom panel. The touch panel has capacity to detect spatial location of fingers, hands & wrist along with amount of pressure at specific touch points.
An active stylus device capable of detecting proximity, kinetic state, orientation, pressure, tilt and touch.
The definition to the touch pad surface that visually distinguishes areas as keyboard or touch pad or combination as per mode selected is achieved by:
   1. Permanent marking on the surface (example stick on/paint),
   2. By backlighting or;
   3. By a sophisticated display device.
The device with new hardware is shown in FIG. 3. It is to be noted that bottom panel in FIG. 3 contains new hardware and a stylus device is added.

Governing Software:
The software controls the hardware and enables selected mode as per active application, input from sensors and user overrides.
Software lets user to choose from a variety of keyboards (e.g.: International, QWERTY, Teller), enables user to select multiple keyboards simultaneously, superimpose keyboards, change, customise, split and orient keyboards.
Software enables the user to customise the touch pad as per one's preferences. For example: Ability to set dedicated OS specific or application keys, set location & size of keys on the bottom panel.

Modes of Operation of HCI Device:

Full Touch Pad Mode: Where the touch pad is used as a canvas for drawing or taking notes.

Keyboard Only Mode: Where the touch pad is only activated for keyboard.
Traditional Mode: Where a keyboard and touch pad is highlighted similar to traditional setup.

Method of Actuation for different Modes:

This section covers how the personality of touch pad is changed between three modes of operation. A combination of multiple sensor inputs, software applications & user preferences is used to decide operational mode.
Based on Stylus State: Based upon the stylus's orientation &/or kinetic state a mode will be selected as follows:
   1. ‘Full Touch Pad Mode’ mode is enabled when stylus is detected to be held in hand in a way being ready to draw or write.
   2. ‘Traditional Mode is selected when stylus is detected stationary or docked.
Based on Hands & Fingers State: Depending upon the orientation &/or location of the hands on the surface of bottom panel:
   1. Keyboard Mode only is activated when palms along with fingers are detected on the touch pad, as in a gesture when one initiates typing on a laptop. Example of gesture is shown in FIG. 4.
   2. The mode of operation changes from keyboard to full touch pad when typing stops and a finger is detected being used in pointing gesture on the bottom panel.
   3. When one hand is detected resting on typing keys and the other one is used to scribble or point with a finger, ‘Traditional Mode’ is activated. Depending upon the next event; if the second-hand joins back the other hand on keyboard then, the ‘Keyboard mode’ enables itself and if the other hand that was on keyboard is taken off then the ‘Full Touch Pad Mode’ gets activated.
Based on Software: A mode is selected based on the active software application, mode & editing state of open document in that active application.
Based on Touch Gestures: A mode is selected based on the executed touch gestures on the bottom panel.
Based Buttons: Buttons physical/virtual on device &/or stylus are used to switch between modes of operation.

Customisation

The HCI device eliminates the traditional physical limitations and is fully customisable. Few examples of user customisation are listed below:
The keyboard is customisable for size as whole & individual key size, type, location, and orientation on the physical panel.
User can create OS function keys and position them to preference.
User can create application specific keys and position them to preference.
One or multiple keyboards can be chosen and laid out on the device side by side, superimposed or in a custom setup as desired by the user.
Parts of panel can be dedicated to specific inputs or switched on/off.
The HCI device is programmable for any type of standard and non-standard keyboards & pointing inputs

HCI Device Types:

Built into the laptop: This type of laptop has the touch pad integrated into the bottom panel as build by original equipment manufacturers and it is referred in FIG. 3.

A Standalone Device for Laptops: A standalone device that sits/clips/attaches on top of bottom panel of a traditional laptops. Covering the keyboard and touchpad and taking over its capability. A standalone HCI device for laptop is shown in FIG. 5.
The standalone device operates using wired or wireless capabilities. It has connection points on the sides.
The standalone device connects to the host laptop using existing ports example USB, Thunderbolt etc. etc or via Bluetooth.
The standalone device draws power from the host laptop and may or may not have battery backup.

A Standalone Device for Desktop Computer: A standalone device that replaces keyboard and mouse on desktop computers with a touchpad. A standalone HCI device for desktop is shown in FIG. 6.
The desktop standalone device works using a wired or wireless connection.
The desktop standalone device can either be fully portable with battery and wireless capabilities or host dependent for power & communication via a cable.

### BRIEF DESCRIPTION OF VIEWS OF DRAWINGS

FIG. 1: Isometric view of different versions of traditional laptop devices in the market.

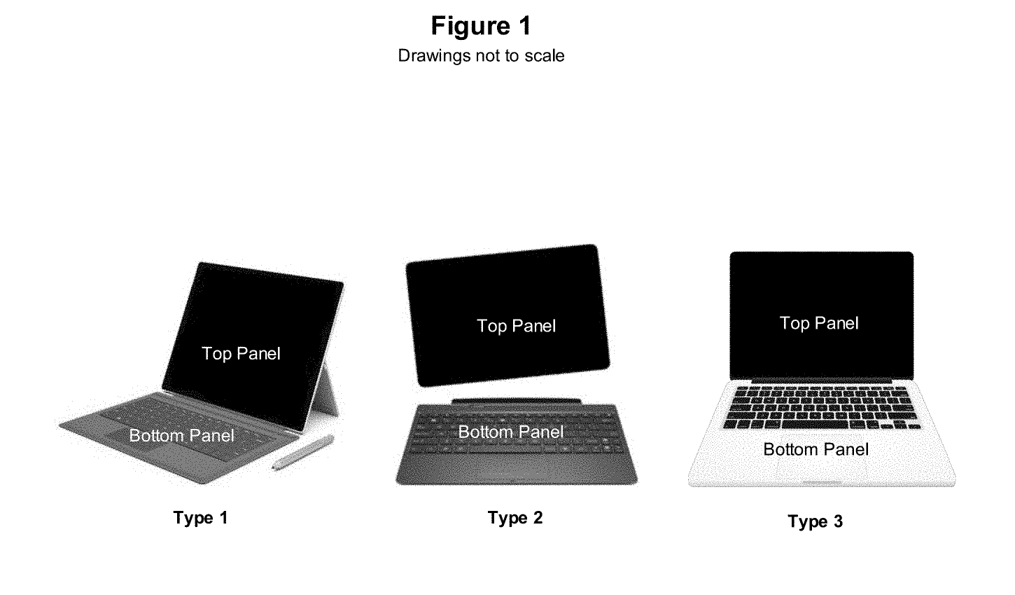

FIG. 2: Traditional laptop front view showing prime components.

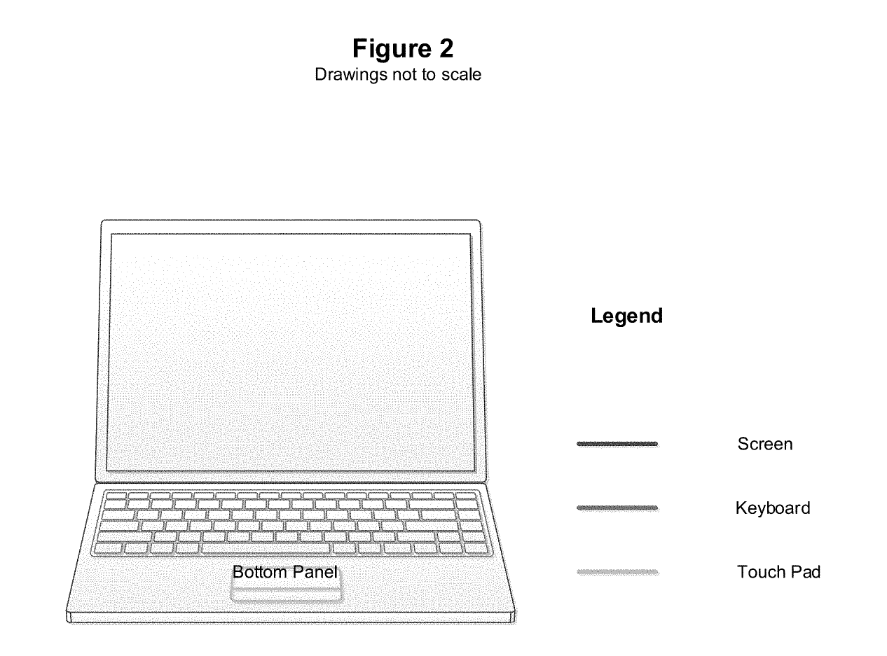

FIG. 3: Front view of the laptop device configured with new hardware showing top as screen and bottom panel as touch pad.

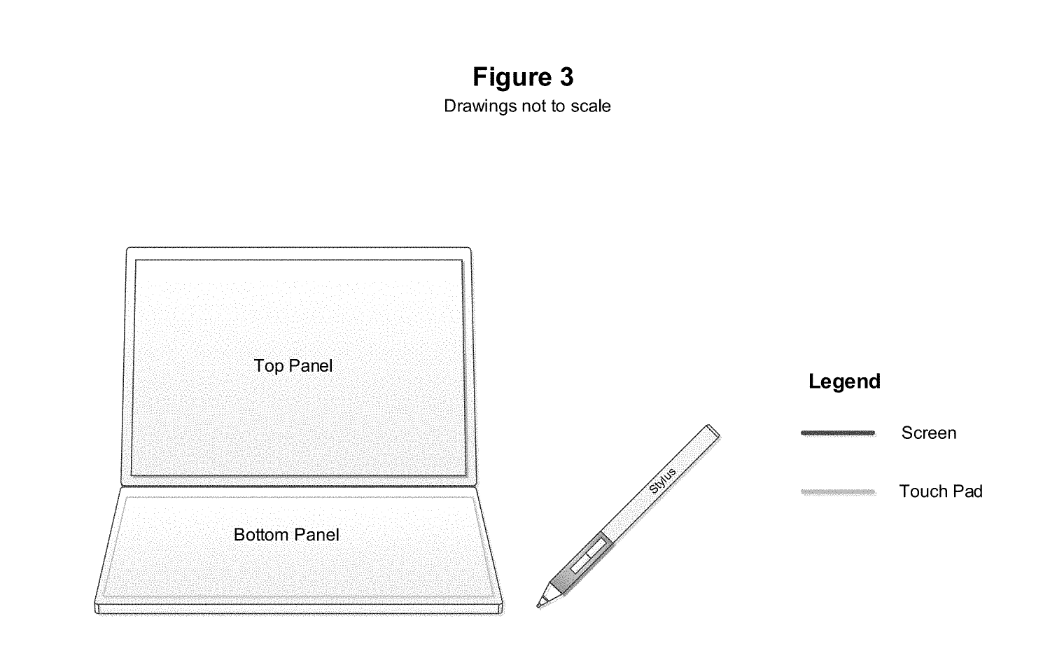

FIG. 4: Top view of hands on traditional laptop showing typing gesture and relative hands location.

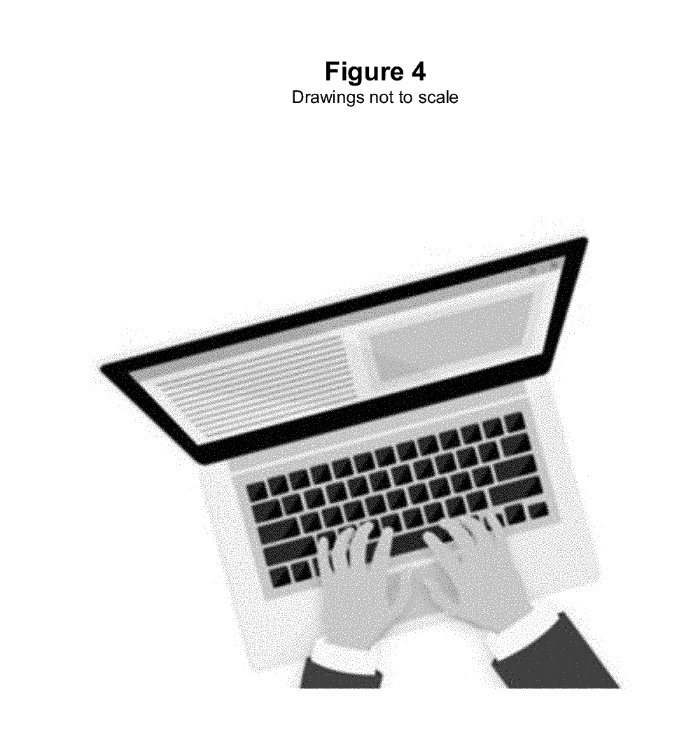

FIG. 5: Front isometric view of standalone device for traditional laptops. The view shows the device is covering half of the traditional laptop and when fully installed it will cover the full bottom panel of traditional laptop.

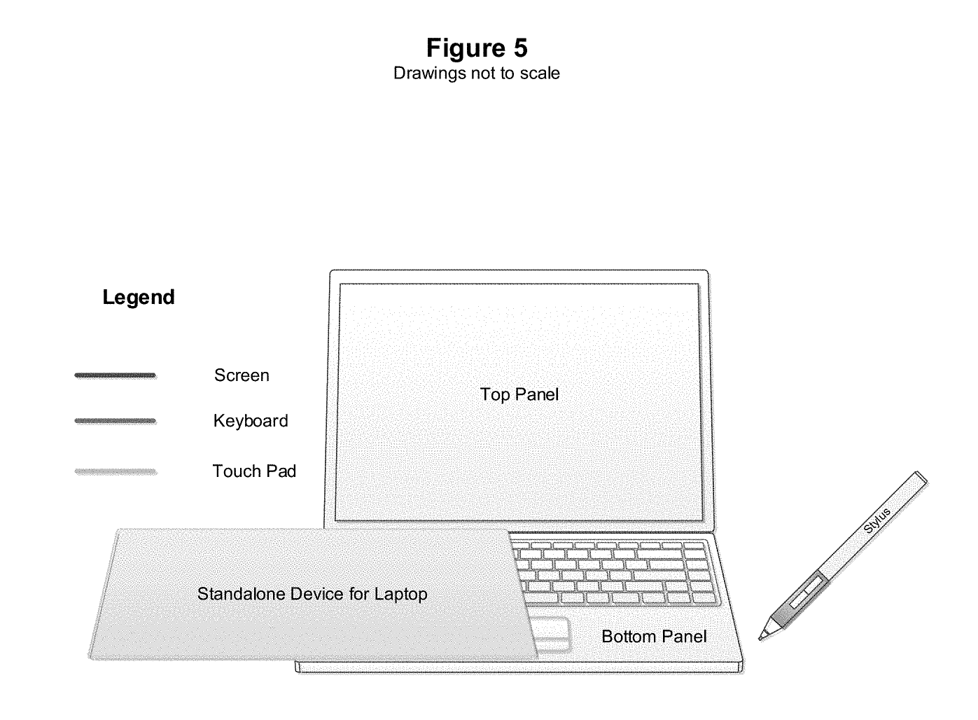

FIG. 6: Top side isometric view of standalone device for desktop computers.

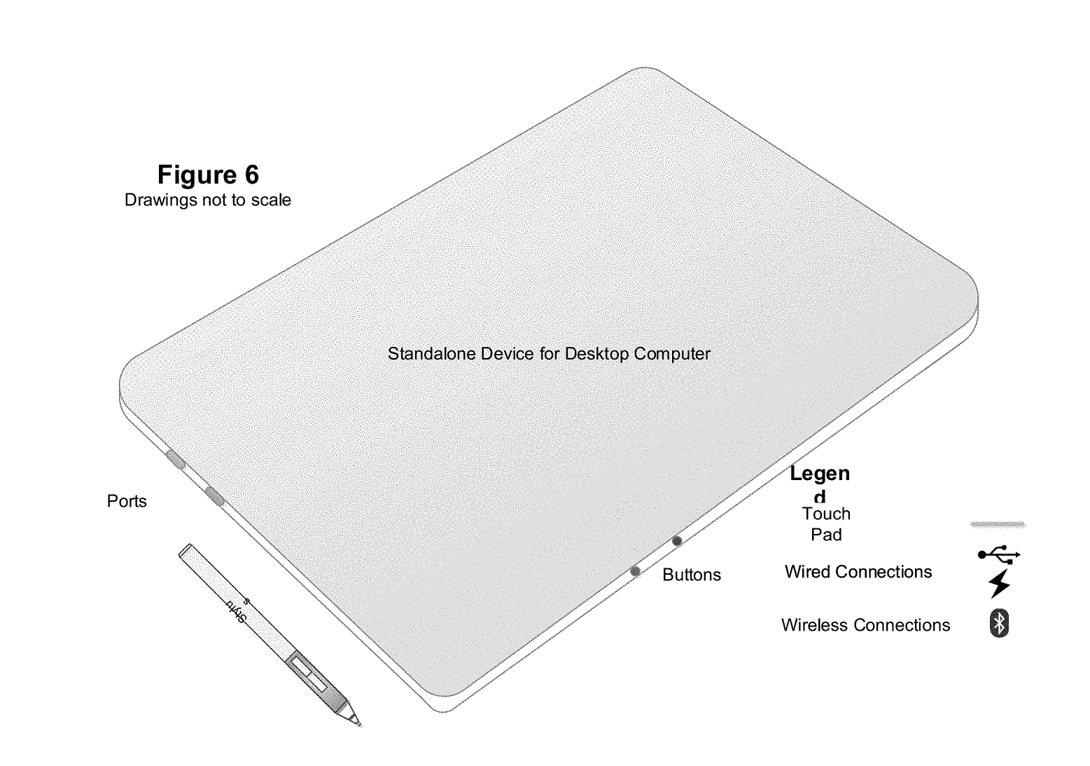

1. Hardware configuration and layout on:
A laptop bottom panel (refer section 2.3.2.1).
A standalone device (refer section 2.3.2.6).
Modes of Operation
Ability to configure HCI device into Full Touch Pad (refer section 2.3.2.3).
Ability to configure HCI device into Keyboard Only mode (refer section 2 3.2.3).
Ability to configure HCI device into Traditional Mode (refer section 2.3.2.3).
Methods of Operation & Customisation.
Smarts to select a mode of operation based on feedback from stylus sensors (refer section 2.3.2.4).
Smarts to select a mode of operation based on orientation and/or location of human palms, hands, fingers &/or combination of these on the surface of bottom panel (refer section 2.3.2.4)
Ability to select/change mode of operation based upon certain gesture performed on the bottom panel (refer section 2.3.2.4).
Ability to create behaviour rules to select mode of operation based on certain static inputs & non-static inputs (refer section 2.3.2.4).
Smart ability to change the mode of operation by using physical or virtual button on panel or stylus (refer section 2.3.2.4).
Ability to customise the bottom panel based on user preferences (refer section 2.3.2.5).
